(19) United States
(12) Patent Application Publication
(10) Pub. No.: US 2023/0311248 A1
(43) Pub. Date: Oct. 5, 2023

(54) GLASS ELEMENT WITH STRUCTURED WALL AND METHOD FOR THE PRODUCTION THEREOF

(71) Applicant: SCHOTT AG, Mainz (DE)

(72) Inventors: Andreas ORTNER, Gau-Algesheim (DE); Fabian WAGNER, Mainz (DE); Markus HEISS-CHOUQUET, Bischofsheim (DE); Michael DRISCH, Mainz (DE); Vanessa GLÄßER, Mainz (DE); Annika HÖRBERG, Mainz (DE); Lukas WALTER, Hattenheim (DE); Lars MÜLLER, Wiesbaden (DE); David SOHR, Mainz (DE); Michael KLUGE, Offenbach am Main (DE); Bernd HOPPE, Ingelheim (DE); Andreas KOGLBAUER, Trebur (DE); Stefan MUTH, Ober-Olm (DE); Ulrich PEUCHERT, Bodenheim (DE)

(73) Assignee: SCHOTT AG, Mainz (DE)

(21) Appl. No.: 18/300,087

(22) Filed: Apr. 13, 2023

Related U.S. Application Data
(63) Continuation of application No. PCT/EP2021/077030, filed on Sep. 30, 2021.

(30) Foreign Application Priority Data
Oct. 13, 2020 (DE) 10 2020 126 856.4

(51) Int. Cl. B23K 26/50; B23K 26/0622; B23K 26/362

(52) U.S. Cl. CPC B23K 26/50; B23K 26/0624; B23K 26/362; B23K 2103/54

(57) ABSTRACT

A panel-shaped glass element is provided that includes vitreous material having a thermal expansion coefficient of less than 10×10⁻⁶ K⁻¹ as well as two opposing surfaces. The glass element furthermore has at least one recess which runs through the glass of the glass element and has a recess wall which runs around the recess and adjoins the two opposing surfaces. The recess wall has a structure with a multiplicity of mutually adjacent rounded dome-shaped depressions. A roughness of the recess wall is formed by these depressions as well as the ridges enclosing the depressions. The recess wall has a mean roughness value (Ra) which is less than 5 µm.

### CROSS REFERENCE TO RELATED APPLICATIONS

This application is a continuation of International Application PCT/EP2021/077030 filed on Sep. 30, 2021, which claims the benefit under 35 USC §119 of German Application DE 10 2020 126 856.4 filed on Oct. 13, 2020, the entire contents of all of which are incorporated herein in their entirety.

### BACKGROUND

### 1. Field of the Invention

The invention relates to a panel-shaped glass element which comprises vitreous material having a thermal expansion coefficient of less than 10×10⁻⁶ K⁻¹ as well as two opposing surfaces, and a recess which runs through the glass of the glass element and has a structured recess wall. The invention furthermore relates to a method for producing the panel-shaped glass element having a structured wall, the structure of the recess wall being deliberately adjusted by adjusting the laser parameters.

### 2. Description of Related Art

The precise structuring of glasses is of great interest in many application areas. Inter alia, glass substrates are used in the fields of camera imaging, in particular 3D camera imaging, in electro-optics, for example L(E)Ds, microfluidics, optical diagnosis, sensing, for example pressure sensing, and diagnostic technology. Such application fields relate for example to light sensors, camera sensors, pressure sensors, light-emitting diodes and laser diodes. Here, glass substrates usually in the form of thin wafers or glass membranes are used as components. In order to be able to use such glass substrates in technical applications, or components, that are becoming smaller and smaller, accuracies in the range of a few micrometers are needed. The processing of the glass substrates in this case concerns holes, cavities and openings in all kinds of shapes, which are introduced into or through the glass substrates, as well as the structuring of surfaces of the substrates. Accordingly, structures in the range of a few micrometers need to be introduced into the substrates.

In order to be able to use the glass substrates in a wide application area, the processing also should not leave behind any damage, residues or stresses in the edge region or volume of the substrate. Furthermore, the method for producing these substrates should allow a manufacturing process that is as efficient as possible.

For structuring inside a glass substrate, for example in order to produce holes and openings, various methods may be applied.

Besides water jet cutting and sandblasting through corresponding masks, ultrasonic machining is an established method. In respect of their scaling, however, these methods are limited to small structures, which are typically about 400 µm in the case of ultrasonic machining and at least 100 µm in the case of sandblasting. In the case of water jet cutting and sandblasting, stresses are generated in the glass due to the mechanical erosion, and these are associated with flaking in the hole edge region. For the structuring of thin glasses, neither method is usable in principle. Since these methods operate in the range of a few hundred µm, this applies not only to the dimensions of the holes, cavities and openings to be generated, but above all to the surfaces thereby created in the substrate. The aforementioned methods are therefore unsuitable for generating microstructures in substrates.

The use of laser sources for the structuring of a wide range of materials has therefore become established recently. Using a wide variety of solid-state lasers with an infrared (for example 1064 nm), green (532 nm) and UV (365 nm) wavelength, or extremely short wavelengths (for example 193 nm, 248 nm), smaller structures may be introduced into a glass substrate than is possible with the aforementioned mechanical methods. Since glasses have a low thermal conductivity and furthermore exhibit a high susceptibility to fracture, however, laser processing in the production of very fine structures may also lead to high thermal loading of the glass and therefore to critical stresses, even to the extent of microcracks and deformations in the edge region of holes. Larger-area structures on the surface of substrates may also be generated only with very great outlay, if at all, when using a fine laser beam whose diameter often amounts only to a few micrometers. The method is therefore only partially suitable for use in industrial manufacture of substrates which need to be specially structured on the surface in the region of openings.

This applies above all to components, or substrates, which need to be suitable for special applications. Examples which may be mentioned are glass substrates for microfluid cells, which require a particularly smooth surface inside the fluid channels in order to reduce the resistance of the fluid on the channel walls to a minimum. Another application field is electro-optical transducers having customized glass spacers. These allow the adjustment of a defined distance between different active and passive components or make contributions to the encapsulation and protection of electromagnetic transducers/emitters/receivers, etc., inter alia for the purpose of protecting the vulnerable components. In order to fix or even insulate these vulnerable components in the best possible way inside the openings of the substrate, or spacer, special structurings of the opening surfaces of the substrate are necessary. Furthermore, particular optical properties of the substrate are often needed, for example for the purposes of improved light guiding, which could be achieved by a defined structure of the opening surface which refracts light in a defined way.

Known methods, however, are not capable of generating such structures. With abrasive methods, as mentioned above, microstructural openings cannot be produced and their opening surfaces of the substrates therefore also cannot be deliberately adjusted. With known laser methods, although microstructures in the form of through-openings can be achieved to a certain extent, a substrate surface which runs parallel to the laser beam cannot be processed by the latter since the laser beams predominantly “shoot” through the substrate. Reprocessing the opening surfaces of every opening of a substrate by means of a laser beam would be extremely time-consuming and cost-intensive, and therefore not economical. Furthermore, such processing of the openings is also only possible to a limited extent because of the angle of incidence of the laser.

### SUMMARY

The object of the invention is therefore to provide a substrate having specially structured opening surfaces, as well as a method for generating it. This object is achieved by the subject matter of the independent claims. Advantageous developments are specified in the respective dependent claims.

Accordingly, the invention relates to a panel-shaped glass element which comprises vitreous material having a thermal expansion coefficient of less than 10×10⁻⁶ K⁻¹ as well as two opposing surfaces. The glass element furthermore has at least one recess which connects the two surfaces and opens into the surfaces, and runs through the glass of the glass element, having a recess depth which is transverse, preferably perpendicular, to at least one of the surfaces of the glass element and corresponds to a thickness of the glass element. The recess has a recess wall which runs around the recess and adjoins the two opposing surfaces. The recess wall has a structure which comprises a multiplicity of mutually adjacent rounded dome-shaped depressions. A roughness of the recess wall is formed by these depressions as well as the ridges enclosing the depressions. The recess wall has a mean roughness value (Ra) which is less than 5 µm, preferably less than 3 µm, preferably less than 1 µm, particularly preferably less than 500 nm. According to another embodiment, however, the wall has a minimum roughness. In particular, the mean roughness value of the recess wall is at least 50 nm.

Owing to the particularly smooth recess wall of the glass element, the glass element is suitable in particular for application in the field of microfluidics. The recess may in this case be configured as an elongated fluid channel through which the fluid can flow substantially unimpeded. The two surfaces may in this case also run parallel to one another. This has the advantage that a plurality of glass elements may be arranged in a plane-parallel fashion above one another and in such an arrangement an offset is not formed. In this way, a plurality of glass elements may be arranged above one another in a sandwich structure. This is necessary particularly in microfluid cells, in which three or more components are usually arranged above one another in order to steer the fluid through the channel, the channel being bounded on two sides by the components arranged above/below.

In one particular embodiment, the mean roughness value (Ra) of the recess wall and/or of an outer wall is at least 50 nm, preferably more than 0.2 µm, preferably more than 0.4 µm, preferably more than 0.5 µm. Not only does such a low roughness allow use in microfluidics, but special optical properties may also be achieved. This is the case particularly when the roughness lies in a range of between 5 µm and 0.2 µm. For example, the glass element has a more matt surface of the recess wall with an Ra of 5 µm than with an Ra of 0.2 µm.

Preferably, the dome-shaped depressions have a depth which is less than 10 µm, preferably less than 5 µm, preferably less than 2 µm, the depth being defined by a difference between a center of a depression hollow and a average peak of the ridge enclosing the depression. In the context of the invention, dome-shaped is intended to mean that the recess wall has curvatures, the curvature being concavely pronounced, in particular with a depression in the direction of the glass of the glass element, and the curvature may protrude in the shape of a dome into the glass element, without restriction to a particular cross section. Preferably, the roughness of the recess wall is defined by the depth of the dome-shaped depressions. This means that the depth of the depressions determines the mean roughness value in the context of the invention. Thus, if the depth is less than 10 µm, the mean roughness value is also less than 10 µm. It is also conceivable for the depth of the depressions to be more than 0.2 µm, preferably more than 0.4 µm, preferably more than 0.5 µm. Dome-shaped depressions ensure impeded crack formation, or crack propagation, since the crack growth is interrupted by irregularities, and especially by curvatures.

All the dome-shaped depressions may have an approximately uniform depth, or for example they may have different depths. It is also possible for the dome-shaped depressions to be arranged with a height offset. This means that some depressions are arranged offset relative to other depressions, in particular from an imaginary central face of the recess wall in a direction perpendicular to this face. The depressions may in this case also be offset regionally relative to the imaginary central face of the recess wall, regionally meaning that there are a multiplicity of depressions which are offset by a similar amount. Preferably, the dome-shaped depressions are offset by an amount which is less than 0.6 µm, preferably less than 0.4 µm, preferably less than 0.2 µm. It is furthermore possible for such regions to be configured in the form of points or strips, for example in the form of strips, in which case the strips may be oriented transversely or parallel to the surface of the glass element. In this way, grooves may be formed on the recess wall, and these may in particular be oriented transversely and/or parallel to the surface of the glass element. Such grooves may in particular ensure better holding of components which are arranged inside the recesses of the glass element, or of the glass substrate.

In one advantageous embodiment, a cross section, or a transverse dimension or a diameter, of a dome-shaped depression is less than 20 µm, preferably less than 15 µm, preferably less than 10 µm. Some depressions may, however, also have a diameter or cross section which is less than 60 µm, preferably less than 50 µm, preferably less than 40 µm. By an expedient selection of the size or dimensions of the depressions, a friction or a resistance of a component or fluid relative to the recess wall may for example be established, so that a component can be fixed better or a fluid can flow better through the recess. In this case, it is conceivable for the dome-shaped depressions to have at least one of the following shapes: circular, oval, vermiform, or roundedly lengthened, for example by a plurality of joined depressions, polygonal, for example hexagonal. Furthermore, the ridges may be configured as polygonal boundary lines between the depressions. In this case, an average number of the vertices of the boundary lines of the depressions may preferably be less than eight, preferably less than seven, and in particular 6. The latter feature results when the areas enclosed by most of the dome-shaped depressions are convex in the mathematical sense. By the adjustment of a suitable shape of the depressions, the recess wall or the glass element may be adapted even better to a specific application.

It is also advantageous for the glass element to have an outer wall which runs around the glass element and connects the two surfaces to one another, the outer wall having a structure that has a multiplicity of mutually adjacent rounded dome-shaped depressions. In this case, the outer wall may have features which correspond to the aforementioned embodiments of the recess wall. In this way, the glass element itself may also be arranged securely against slipping inside another component, for example by a particularly rough outer wall.

It is furthermore possible for the recess wall and/or the outer wall to form a rounded edge. In the context of the invention, this is intended to mean that the face(s) of the recess wall and/or outer wall is/are rough, for example structured surface-wide. In other words, the face(s) of the recess wall and/or outer wall has/have a continuous uninterrupted structure of dome-shaped depressions and/or ridges arranged between the depressions. In this way, the recess wall and/or outer wall is protected effectively against crack growth, or crack growth is minimized, so that the glass element is also protected better against microcracks.

In the context of the invention, this is intended to mean that the face(s) of the recess wall and/or outer wall is/are rough, or structured surface-wide. In other words, 80%, 90%, particularly preferably 95% or even 98% of the face(s) of the recess wall and/or outer wall have a continuous uninterrupted structure of dome-shaped depressions and/or ridges arranged between the depressions. In this way, with the method according to the invention it is possible to produce a multiplicity of very small components having at least one structured outer wall and optionally at least one or more structured recess wall(s), which are connected by one or more web-like connection(s) to a holder, in particular a circumferential holder in the form of a frame. For the use of the component, the web-like connection of its holder is separated, for example, by a conventional fracture process, optionally in combination with the introduction of a predetermined breaking point, for example by filamentation along the intended component contour across the web.

It is also conceivable for the transmission of visible light in the wavelength range of 300 nm and 1000 nm through the structured outer wall and/or recess wall and the glass element, and preferably also by a second wall arranged opposite the recess wall and/or outer wall, to be more than 80%, preferably more than 85%, preferably more than 90%, a light direction in this case being oriented perpendicularly to the recess wall and/or outer wall and parallel to at least one surface of the glass element. The optical path may in this case be oriented in such a way that it crosses at least one wall or surface, and preferably two walls or surfaces, of which at least one, preferably both, has/have dome-shaped depressions. Such a high transmission offers the glass element, or the recess wall, a particularly high optical quality. In this way, the glass element is most suitable in particular for optical applications, so that it may for example be used as an optical component or light guide.

In one embodiment, it may furthermore be provided that the recess wall and/or outer wall has a lower reflectance with a mean roughness value of more than 1 µm than with a mean roughness value of less than 1 µm. It may then be the case that the recess wall and/or outer wall has a decreasing reflectance with an increasing mean roughness value. For example, the recess wall and/or outer wall may have a reflectance that is about two times as great with a mean roughness value of 0.5 µm than with a mean roughness value of 1.4 µm. By selection of a particular roughness value of the recess wall and/or outer wall, the glass element may therefore be especially well suited for certain optical applications. Thus, because of their scattering behavior in relation to visible light, recess walls with higher roughness may be distinguished easily by image processing devices from recess walls with lower roughnesses, and may therefore be used for example for orientation of the glass element as a whole.

It may be provided that the roughness of the recess wall and/or outer wall is configured anisotropically, in which case the anisotropy may be expressed as a parameter A. In this case, A is the square of a quotient, the quotient being formed from the average value of the mean roughness values (Ra) of three 30 µm wide measurement bands which are oriented parallel to a side face of the glass element and the average value of the mean roughness values (Ra) of three 30 µm wide measurement bands which are oriented perpendicularly to this side face of the glass element. In other words, the quotient is formed from the average value of the mean roughness values of three measurement bands running along the edge face of the recess to the average value of three measurement bands running perpendicularly thereto. These latter perpendicularly running measurement bands therefore extend from one side face in the direction of the opposing side face. In particular, this anisotropy may be less than 1, preferably less than 0.8, preferably less than 0.6. In the context of the invention, the side face may be understood as at least one of the two opposing surfaces of the glass element. The anisotropy may be formed by the grooves or by an offset of the dome-shaped depressions from one another. The grooves, or the anisotropically configured roughness, in this case ensure that further, for example electrical, components may be placed in the recess and are protected from displacement with increased friction in relation to the recess wall in the event of movements along the recess wall, particularly in a direction perpendicular to the surface of the glass element. In this way, a component placed in the recess remains fixed in the recess, for example even in the event of shock.

It is also provided that the roughness of the recess wall and/or outer wall is configured anisotropically and the anisotropy is expressed as a parameter A, with A being the square of a quotient and the quotient being formed from the average value of the mean roughness values (Ra) of three 30 µm wide measurement bands which are oriented parallel to a side face of the glass element and the average value of the mean roughness values (Ra) of three 30 µm wide measurement bands which are oriented perpendicularly to the side face of the glass element, the anisotropy being more than 1, preferably more than 2, preferably more than 3. In this embodiment, the grooves may be oriented perpendicularly to the glass surface so that the anisotropically configured roughness can ensure that other components, for example electrical components, in the recess are protected from displacement with increased friction in relation to the recess wall in the event of movements along the recess wall, particularly in a direction parallel to the surface of the glass element. On the other hand, the mobility of the component is increased by the grooves arranged perpendicularly to the glass surface, so that the component can be displaced better. This may be advantageous if the component is subject to repeated mechanical loading, for example in the case of a pressure sensor, and both the component and the glass element can be protected from increased abrasion by the mobility of the component inside the glass element.

Overall, in one embodiment it may therefore be advantageous for the anisotropy (A) to be: more than 1, preferably more than 1.5, or even more than 4, or less than 1.

It is even possible for the anisotropy (A) to be more than 8, 9 or 10. In such an embodiment, the grooves may be particularly strongly pronounced.

In another advantageous embodiment, the roughness of the recess wall and/or outer wall is configured direction-dependently, the roughness being differently pronounced at least in sections, and the sections: being oriented transversely to the recess depth or at least one surface, or parallel to the recess depth or at least one surface, a difference in the mean roughness value of the sections being less than 4 µm, preferably less than 2 µm, preferably less than 1 µm. A direction-dependent roughness may, however, also be formed for example by the dome-shaped depressions offset relative to the imaginary central face of the recess wall. The direction-dependent roughness allows the deliberate incorporation of air chambers between the recess wall and a component, for example for improved thermal or electrical insulation. Furthermore, as a result of an expediently selected anisotropic structure, in particular grooves, a fluid may also be guided better through a channel-shaped recess, for example if the grooves are oriented along the flow direction of the fluid, or perpendicularly to the flow direction if a particularly slow flow is intended to be achieved.

In one advantageous embodiment, the glass element may have a thickness which is more than 10 µm, preferably more than 15 µm, preferably more than 20 µm, and/or less than 300 µm, preferably less than 200 µm, preferably less than 100 µm. It is, however, also possible for the thickness to be more than 300 µm or less than 10 µm, preferably less than 4 mm, preferably less than 2 mm, preferably less than 1 mm. Such thin glasses in particular may be structured very finely and without risk of fracture with the method described here. Furthermore, owing to a small thickness, the glass element may be configured flexibly so that it can be bent. Since other bonding forces often play a substantial part because of a small thickness, the glass element may furthermore be configured a greater mechanical stability in relation to externally applied mechanical stress. These advantages allow use of the glass element for example in IC packages, biochips, sensors, camera imaging modules and diagnostic technology equipment.

In other embodiments, glass elements which do not deform, or deform only very slightly, under the effect of force, from the thickness range of between 300 µm and 3 mm, in particular cases even up to 6 mm, may also be used.

In another embodiment, the glass element has a transverse dimension of more than 50 mm, preferably more than 100 mm, preferably more than 200 mm and/or less than 500 mm, preferably less than 400 mm, preferably less than 300 mm. Small glass parts, preferably each having one or more recesses, may then be divided from such glass elements. According to another embodiment, such small glass elements or glass parts may have a transverse dimension of at most 5 mm, preferably at most 2 mm. With such dimensions, the glass element may be used optimally as a component for microtechnology.

In another advantageous embodiment, the glass of the glass element has at least one of the following constituents: an SiO₂ fraction of at least 30 wt%, preferably at least 50 wt%, particularly preferably at least 80 wt% and a TiO₂ fraction of at most 10 wt%.

Ideally, the glass of the glass element is configured as a borosilicate glass. Such glasses have a particularly high thermal stability, transparency as well as chemical and mechanical stability, and are therefore best suited for a wide application field, for example for both optical and electronic applications.

The object is also achieved by a method for producing a panel-shaped glass element having a structured wall or a panel-shaped glass element according to at least one of the embodiments mentioned above. The glass element comprises vitreous material having a thermal expansion coefficient of less than 10×10⁻⁶ K⁻¹ as well as two opposing surfaces, wherein during the method the glass element is provided, the laser beam of an ultrashort-pulse laser is directed onto one of the surfaces of the glass element and is concentrated by focusing optics in order to form an elongate focus in the glass element, a multiplicity of filamentary channels being generated in the volume of the glass element by the incident energy of the laser beam, their depth running transversely to the surface of the glass element, the channels being arranged at a distance from one another, the glass element is exposed to an etchant which erodes glass of the glass element with an erosion rate, the channels being widened by the etchant so that a recess having a structured recess wall is formed, the recess wall running around the recess and adjoining the two opposing surfaces, and having a structure which comprises a multiplicity of mutually adjacent rounded dome-shaped depressions by which a roughness of the recess wall is formed. The recess wall may in this case also be understood as an inner edge of the recess.

In a preferred embodiment, the arrangement of the filamentary channels is carried out along a closed contour, which may in principle have any desired two-dimensional shape. In a preferred embodiment, the contour follows regular two-dimensional geometrical elements, such as circles, ellipses, rectangles, squares or polygons, so that after manufacture of the structured glass substrate the recess according to the invention may be used for example as a receptacle for electronic components.

By adjustment of the laser parameters, the structure of the recess wall or the roughness is preferably adjusted deliberately in order to generate a mean roughness value (Ra) of the recess wall which is less than 5 µm, preferably less than 3 µm, preferably less than 1 µm. The mean roughness value is, however, preferably at least 50 nm.

In this way, recesses and/or outer walls having different roughnesses may be generated on a substrate, the difference of the roughnesses of the recesses and/or outer walls being at least more than 0.5 µm, preferably more than 1 µm, or particularly preferably more than 2 µm. Thus, for example, a plurality of recesses with the same or different roughnesses for components may be introduced in a substrate, besides additional recesses with greater roughness for orientation of the component as a whole in a reference system. In another embodiment, the recesses for components may be provided with an isotropic roughnesses in order to be able to ensure not only optimal alignment but also ideal seating of the components in their recesses in the subsequent application process.

It is provided that a glass element according to the embodiments mentioned above may also be manufactured by the method, so that the aforementioned advantages can be achieved. In this case, the method is most suitable especially for an industrial manufacturing process since it allows the simultaneous generation of a multiplicity of recesses in a plurality of glass elements. In a first method step, at least one glass element, in particular without recesses, is provided. In a further, in particular second, step, at least one damage, but preferably a plurality and particularly preferably a multiplicity of damages are generated in the glass element, particularly in the form of filamentary channels, in order ideally to be able to form a perforation of the glass element by the damages/channels, which are preferably widened in the course of the following etching process to such an extent that the channels join up and individual parts of the glass element can thereby be detached from the glass element, and the recess can in this way be formed.

For this purpose, a plurality of damages/channels are preferably generated next to one another in such a way that a row of recesses constitutes a larger structure, ideally in the form of the recess(es) to be generated. The damages/channels run in their longitudinal direction transversely to at least one surface, ideally both surfaces, of the glass element. In this case the channels extend from one surface, and in particular perpendicularly from this surface, through the glass element to the other surface arranged opposite, and penetrate through both surfaces.

The damages/channels are generated in the glass element with the aid of at least one laser beam of an ultrashort-pulse laser. The generation of the recesses by means of the laser is preferably based on a plurality of the steps mentioned below: the laser beam of the ultrashort-pulse laser is directed onto one of the surfaces of the glass element. It may be concentrated by focusing optics to form an elongate focus in the glass element. In this case, the emission wavelength(s) may be selected in such a way that the glass element is substantially transparent, that is to say there is a transmittance of more than 0.9, preferably 0.95, particularly preferably more than 0.98, the ultrashort-pulse laser emits one or more pulses or pulse groups (so-called burst pulses) onto the glass element, and nonlinear absorption of the laser energy is in this case preferably initiated by the interaction between the electromagnetic field of the high-power laser pulse and the glass element, which preferably induces filamentary damage (particularly in the form of a substantially cylindrical channel) in the material of the glass element at the position of the elongate focus, and widens the filamentary damage to form a channel, in this way, a multiplicity of channels are generated, the channels, in particular the arrangement thereof, respectively in the glass element being selected in such a way that many channels arranged next to one another form an outline of a recess to be generated. In this case, the channels may be arranged at a distance from one another.

A suitable laser source according to the present invention is a neodymium-doped yttrium aluminum garnet laser (Nd:YAG laser) having a wavelength of 1064 nanometers. The laser source generates, for example, a raw beam having a (1/e²) diameter of 12 mm, and a biconvex lens having a focal length of 16 mm may be used as the optics. In order to generate the raw beam, suitable beam-shaping optics may be employed, for example a Galilean telescope. The laser source operates in particular with a repetition rate that lies between 1 kHz and 1000 kHz, preferably between 2 kHz and 100 kHz, particularly preferably between 3 kHz and 200 kHz. This repetition rate and/or the scan speed may in this case be selected in such a way that a desired spacing of neighboring damages/channels is achieved.

Other variants of the Nd:YAG laser, such as the wavelengths 532 nm or 355 nm generated by frequency doubling (SHG) or frequency tripling (THG), or the Yb:YAG laser (emission wavelength 1030 nm), may be used in a suitable way as beam sources.

It is also conceivable for a laser pulse to be divided into a multiplicity of individual pulses, and for the multiplicity to be less than 10, preferably less than 8, preferably less than 7 and/or more than 1, preferably more than 2, preferably more than 3. These individual pulses may be combined to form a pulse packet, a so-called burst, and in particular they are emitted in consecutive laser pulses. Preferably, these individual pulses are directed onto the same point, or the same position, on the glass surface so that the damages become increasingly wide owing to successive individual pulses, and channels which preferably run through the entire thickness or volume of the glass element are formed.

Advantageously, the recess wall/channel wall to be generated may be influenced by an expedient selection of the number of individual pulses within a pulse packet, and in particular a structure of the recess wall/channel wall may be deliberately adjusted. Since the total power of a laser pulse in a pulse packet, or in a burst, is distributed over a plurality of individual pulses, each pulse has a lower energy in comparison with a single laser pulse. The result of this is that with a larger number of individual pulses, the energy of each individual single pulse decreases. It may, however, be provided that the pulse energies of the individual pulses are flexibly adjustable, in particular that either the pulse energies remain substantially constant or the pulse energies increase or the pulse energies decrease, in which case the first individual pulse of a burst, or pulse packet, then preferably has either the lowest or highest energy of the individual pulses. Furthermore, in the case of operating the ultrashort-pulse laser in burst mode, the repetition rate may be the recurrence rate of the emission of bursts. Furthermore, the individual pulses impinge on the surface of the glass element, or in the damage, with a time offset so that each individual pulse modifies the previously generated state of the recess wall/channel wall. In this way, the recess wall/channel wall may be deliberately structured and modified by selecting the number of individual pulses of a burst.

The typical power of the laser source in this case particularly favorably lies in a range of from 20 to 300 watts. In order to achieve the damages/channels, according to an advantageous development of the invention a pulse energy of the pulses and/or of pulse packets of more than 400 microjoules is used, more advantageously a total energy of more than 500 microjoules. A suitable pulse duration of a laser pulse lies in a range of less than 100 picoseconds, preferably less than 20 picoseconds.

It may, however, also be provided that a pulse duration that is less than 15 ps, preferably less than 10 ps, preferably less than 5 ps is selected. Preferably, a pulse duration of 1 ps is even used in order to generate a smooth recess wall/channel wall, in particular having a low roughness, or a low mean roughness value. The roughness may in this case be increased with an increasing pulse duration. One reason for this may be the thermal behavior of the glass, since with a longer pulse duration the glass is consequently exposed for longer to the energy of the laser, and therefore also to the laser beam heat thereby produced, so that in particular glass which is thermally not very stable is damaged, for example by expansion. Consequently, the glass of the glass element may be damaged in a particular way by precise selection of the pulse duration and therefore ideally also a roughness of the recess wall/channel wall. This may likewise mean that glass having a low thermal expansion coefficient is damaged less strongly than glass having a higher thermal expansion coefficient. The pulse duration is in this case substantially independent of whether a laser is operated in single-pulse operation or in burst mode. The pulses within a burst typically have a similar pulse length to a pulse in single-pulse operation. The burst frequency may in this case lie in the range of from 15 MHz to 90 MHz, preferably in the range of from 20 MHz to 85 MHz, and is for example 50 MHz.

It is also advantageous for the channels to be arranged at a distance from one another, and for this distance to be less than 20 µm, preferably less than 15 µm, preferably less than 10 µm and/or more than 1 µm, preferably more than 2 µm, preferably more than 3 µm. The spacing of the channels may, however, also be more than 5 µm and/or less than 100 µm, preferably less than 50 µm, preferably less than 15 µm.

Irrespective of the diameter of the channels, the distance of neighboring channels from one another may also be referred to as a pitch, that is to say for example a spacing of the laser pulses which are emitted simultaneously or in particular successively, offset by a distance from one another. This distance is measured from channel middle to channel middle, or from the center of a pulse to the center of an adjacently emitted pulse. With the selection of the spacing of the channels, the roughness may be influenced insofar as the sections between the channels, which in particular have dimensions that correspond to the thickness of the glass element and the spacing of the channels, purposely do not need to be processed by the laser and are only subjected to a subsequent etching process.

Accordingly, two different regions can thus be generated, those whose surface is structured with a laser, and preferably an etchant, and those whose surface is structured only with the aid of the etchant to which the glass element is exposed after the generation of the channels. In this way, in particular, direction-dependent or anisotropic roughnesses of the recess wall may be generated. The regions between the channels may in this case preferably have a different roughness than the regions of the channels, a longitudinal extent of both regions preferably running parallel to the laser beam or transversely, in particular perpendicularly, to at least one surface of the glass element, so that ideally an anisotropy of more than 1 may be formed.

In a further, preferably final step, the glass element, including the channels generated therein, is exposed to an etchant in order to erode glass of the glass element with an erosion rate that can be set, the channels being widened by the etchant and in particular the erosion resulting therefrom. In this way, the recess, and preferably also a plurality of recesses, may be formed with a structured recess wall. Typically, the dome-shaped depressions of the recess wall and/or of the outer wall may in this case be generated by the erosion. It is advantageous for a container, for example a tank, a pot or a vat, to be filled with the etchant and in particular for one or more glass elements subsequently to be held or immersed at least partially in the container, that is to say in the etchant.

The etchant may be gaseous, although it is preferably an etching solution. According to one embodiment, the etching is therefore carried out wet-chemically. This is favorable in order to remove glass constituents from a channel inner face during the etching. If the channel wall is for example configured particularly unevenly or planar by selecting suitable laser parameters, for example the burst, pitch and/or pulse duration, the depressions may be added by the etching, or the wet-chemical etching erosion or material erosion of the recess wall/channel wall. In this way, the recess wall may be provided, or generated, according to requirements with a high or low roughness, and in particular the advantageous dome-shaped depressions.

As an etching solution, it is provided to use an acidic or alkaline solution. Suitable as acidic etchants are in particular HF, HCl, H₂SO₄, ammonium bifluoride, HNO₃ solutions or mixtures of these acids. For basic etchants, KOH or NaOH bases may be envisioned, for example. These are particularly efficient for glass compositions having a low alkali metal content since the basic etching solutions oversaturate less rapidly in the case of such glasses, and can therefore maintain their etching ability substantially longer than would be the case with strongly alkaline glasses. Ideally, the etchant to be used should therefore be selected according to the glass to be etched of the glass element. Accordingly, depending on the glass composition, an acidic etchant may be selected in order to set a rapid erosion rate for silicate glasses, or a basic, in particular alkaline etchant in order to set a slow erosion rate.

The etching is preferably carried out at a temperature higher than 40° C., preferably higher than 50° C., preferably higher than 60° C. and/or lower than 150° C., preferably lower than 130° C., preferably lower than 110° C., and in particular up to 100° C. This temperature provides a sufficient mobility of the ions or constituents to be dissolved of the glass of the glass element from the glass matrix.

A further factor is time. In general, for example, more erosion may be achieved if the glass element is exposed to the etchant for several hours, in particular longer than 30 hours. On the other hand, it is possible to limit the erosion by exposing the glass element to the etchant for less than 30 hours, for example only 10 hours. In the best case, the erosion rate is selected so that the dome-shaped depressions form a shape which, with a mathematically smallest outline or cross section, has the greatest spatial content, in particular a circular shape, or an approximately hexagonal or polygonal shape. In this way, a uniform roughness of the recess wall may be achieved.

### BRIEF DESCRIPTION OF THE DRAWINGS

The invention will be explained in more detail below with the aid of the appended figures. In the figures, references which are the same respectively denote elements that are the same or correspond to one another.

FIG. 1 shows a schematic representation of the generation of damage in the laser element by a laser;

FIG. 2 shows a schematic representation of a glass element having a plurality of damages;

FIG. 3 shows a schematic representation of a process of etching the glass element;

FIG. 4 shows a schematic representation of the glass element after the etching process and the separation of a part in order to generate the recess;

FIG. 5 shows an electron microscopy image of a recess wall of a glass element;

FIG. 6 shows measurement results of the roughness of the recess wall as a function of the pulse duration;

FIG. 7 shows measurement results of the roughness of the recess wall as a function of the burst;

FIG. 8 shows measurement results of the roughness of the recess wall as a function of the pitch;

FIG. 9 shows a surface measurement result of the recess wall having strong isotropy with a pulse duration of 1 ps;

FIG. 10 shows a surface measurement result of the recess wall having strong isotropy parallel to the laser with a pulse duration of 10 ps;

FIG. 11 shows a surface measurement result of the recess wall having strong isotropy perpendicularly to the laser with a pulse duration of 10 ps;

FIG. 12 shows a surface measurement result of the recess wall without significant isotropy with a pulse duration of 10 ps;

FIG. 13 shows a schematic representation of a transmission measurement of the recess wall; and

FIG. 14 shows measurement results of a reflection measurement on the recess wall.

### DETAILED DESCRIPTION

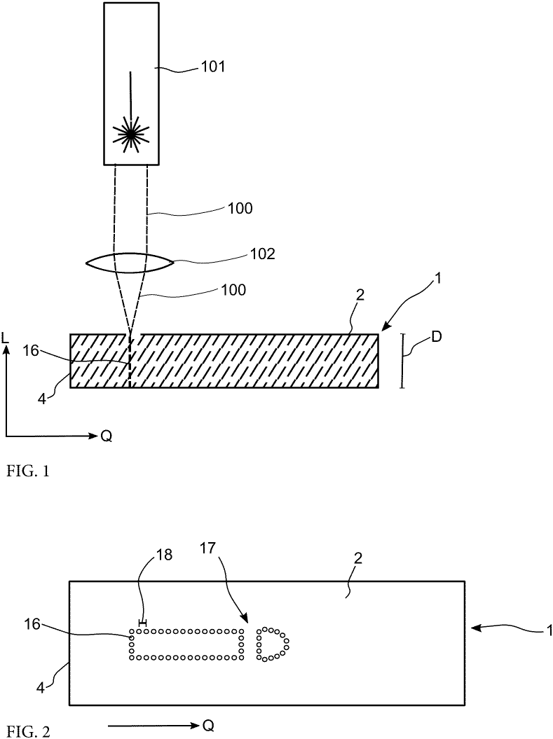

FIG. 1 schematically shows a glass element 1 having two surfaces 2, which are arranged opposite one another so that the volume of the glass element is arranged between the surfaces, as well as a thickness D which defines a spacing of the two surfaces 2. The surfaces may in this case be arranged parallel to one another. The glass element 1 furthermore extends in a longitudinal direction L and a transverse direction Q. The glass element 1 preferably also has at least one outer face 4, which ideally encloses the glass element 1, in particular fully, and the height of which corresponds to the thickness D of the glass element 1. The thickness D of the glass element 1 and the height of the side face 4 in this case ideally extend in the longitudinal direction L, and the surfaces of the glass element may extend in the transverse direction.

In a first method step, damages, particularly in the form of channels 16, or channel-shaped damages 16, are generated in the volume of the glass element 1 by a laser 101, preferably an ultrashort-pulse laser 101. For this purpose, the laser beam 100 is focused and directed onto a surface 2 of the glass element by means of focusing optics 102, for example a lens having uncorrected spherical aberrations, or a lens system which has an increased spherical aberration as the overall effect of the individual elements. By the focusing, in particular elongate focusing of the laser beam 100, onto a region inside the volume of the glass element 1, the consequently incident energy of the laser beam 100 ensures that filamentary damage is generated, and in particular also widened to form a channel 16, for example by using the burst mode in which a plurality of individual pulses in the form of a pulse packet generate the damages, or channels 16.

So that the surface of the recess 10 to be generated can be structured optimally in a later method step, it may be advantageous to adjust particular laser parameters deliberately so that the surfaces of the damages and/or channels are so to speak already pretreated during the generation of the latter. For this purpose, for example, at least one of the following parameters may be adjusted precisely: the pulse durations of the laser beams 100, which preferably lie in the range of picoseconds or femtoseconds, the number of individual pulses in a pulse packet, or in the burst, the spacing of the emitted laser beams 100 relative to one another, that is to say the spacing of the damages/channels 16 generated, the energy of the laser, or the frequency. Without restriction to this embodiment, the frequency of a pulse packet may for example be 12 ns — 48 ns, preferably about 20 ns, in which case the pulse energy may be at least 200 microjoules and the burst energy may correspondingly be at least 400 microjoules. By corresponding selection of particular values of these parameters, the roughness of the recess wall 11 of the recess 10 to be generated may already be deliberately adjusted in advance.

Preferably, as shown in FIG. 2, in further steps a plurality of channels 16 are generated, these ideally being arranged next to one another in such a way that a multiplicity of channels 16 constitutes a perforation and this perforation, or this multiplicity of channels 16, forms outlines of a structure 17. In the best case, a structure 17 generated in such a way corresponds to a shape of a recess 10 to be generated. In other words, a spacing 18 and a number of the channels 16 are selected in such a way that outlines of recesses to be generated are formed. The spacing 18 of the channels 16 in this case corresponds to the pitch of the laser, that is to say the spacing 18 of the laser beams 100 to be emitted.

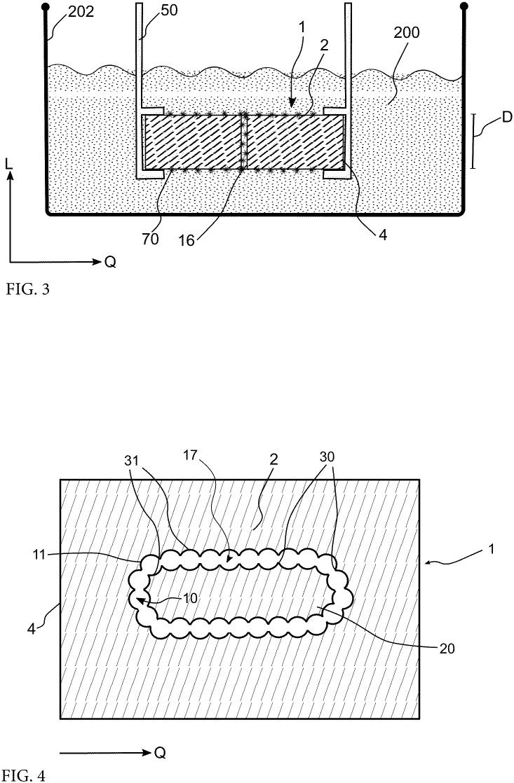

FIG. 3 shows a further step. After a multiplicity of channels 16 have been generated in the glass element 1 by means of the laser 101, the glass element 1 preferably structured by the channels is placed in an etchant 200. For this purpose, the glass element is preferably arranged releasably on holders 50, in which case the glass element 1 may only rest on the holders 50 or may be or have been fixed thereon. The glass element 1 is in this case held by the holders 50, and in particular immersed, in an etchant 200, preferably an etching solution, which is preferably arranged in a container 202. Ideally, for this purpose the container 202 consists of a material which is substantially resistant to the etchant 200. This means that the material of the container 202 is substantially resistant so that the etchant 200 attacks, or erodes, the material of the container only to a very small extent, or that the ions and atoms of the material of the container 202 in contact with the etchant 200 substantially remain in the volume of the container 202, so that the composition of the etchant 200 ideally remains unchanged by contact with the container 202. It is, however, also conceivable that the composition of the etchant 200 is influenced by contact with the container, and in particular the etching ability of the etchant 200 can be modified by container constituents released from the container 202, and the erosion rate of the erosion 70 of the glass element can thereby be modified in a desired direction. The erosion rate may, however, also be modified by a by physical and/or mechanically induced movement of the etchant 200, in particular stirring, for example by magnetic stirrers, or by local temperature variations. Preferably, the etchant 200 is brought to a temperature of between 40° C. and 150° C. in order to achieve an optimal erosion rate.

Preferably, an acidic or alkaline solution is used as the etchant 200, and in particular an alkaline solution, for example KOH. Ideally, a basic etchant 200 having a pH > 12, for example a KOH solution having a concentration > 4 mol/l, preferably > 5 mol/l, particularly preferably > 6 mol/l, but < 30 mol/l is used. Without restriction to this embodiment, the etching is preferably carried out with a temperature of the etchant > 70° C., preferably > 80° C., particularly preferably > 90° C., and especially about 100° C., or at a temperature below 160° C.

The erosion 70, or an erosion rate, may for example be adjusted by the duration for which the glass element 1 is exposed to the etchant 200. For this purpose, the desired erosion 70 is increased when the glass element 1 remains in the etchant 200 for longer. In order to bring the channel wall, or wall of the channels 16, pre-structured by the laser 100 to its target structure, or the desired roughness of the recess 10 or recess wall 11 to be generated, an erosion rate of less than 5 µm/h is optimal. In particular, the desired mean roughness values may also be achieved by means of the total etching duration. For this purpose, it is favorable for the etching duration to be at least 12 hours. The erosion may, however, also vary and be for example 34 µm with an etching duration of 16 hours, 63 µm with 30 hours and 97 µm with 48 hours.

Ideally, the erosion 70 and the etching duration are selected in such a way that the material is eroded between neighboring channels to such an extent that the channels join up, and in particular a continuous opening is generated by the joining up of the channels 16, such as is shown by way of example schematically in FIG. 4. Without restriction to the example shown in FIG. 4, the continuous opening may also assume any other shape and/or outline. What is important, however, is that a large opening is generated by the merging of the channels 16 in the glass element 1, in which case an inner part 20 of the glass element 1 that was previously enclosed by channels is exposed by the channel merging, and in particular may be dissolved or removed. In the course of this, the recess 10 having a recess wall 11 is generated.

Ideally, the recess wall 11 has a uniform structure, in particular with a deliberately adjusted roughness, or mean roughness value. It may, however, also be advantageous for the recess wall 11 to be configured anisotropically, for example by deliberate adjustment of the erosion rate, particularly in a form such that intermediate regions between the channels are eroded only incompletely, or partially, so that the recess wall 11 comprises such intermediate regions 30 as well as channel regions 31. By the alternation of the intermediate regions 30 and the channel regions 31, grooves that preferably form an anisotropic, or direction-dependent, roughness of the recess wall 11 may be formed on the recess wall 11.

In order to be able to adjust the structure, or the roughness, of the recess wall optimally, it may be assumed that at least one of the following relationships exists:

$$\text{burst} \times \text{pulse duration} \text{=} \text{constant}$$

$$\text{pitch} / \text{erosion} \text{=} \text{constant}$$

In view of these relationships, it is clear that the laser parameters, and in particular the pitch and the burst, or the number of individual pulses of a pulse packet, have a considerable influence on the roughness of the recess wall.

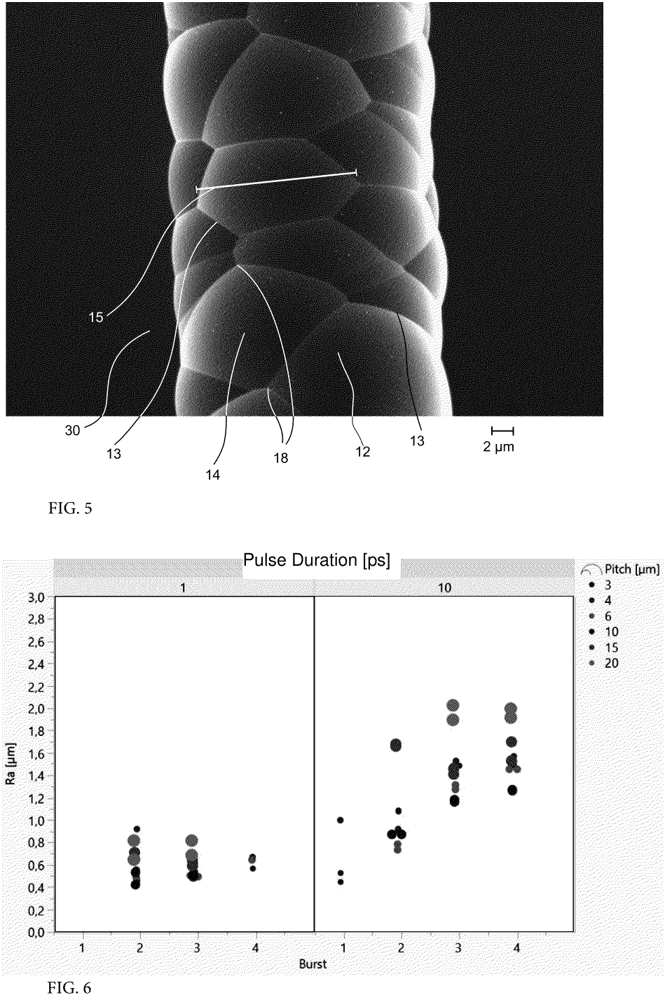

FIG. 5 shows an electron microscopy image of a channel section 31 of the recess wall 11. A multiplicity of dome-shaped depressions 12, which are distributed over the recess wall 11, may be seen clearly. The depressions 12 are in this case arranged in such a way that they adjoin one another, the depressions 12 ideally each being enclosed by a ridge 13, which for example can impede crack growth. As may be seen in the image, the depressions 12 form concave curves, the curvature of which runs in the direction of the glass volume, and in particular the ridges 13 therefore lie higher in relation to a central face than, for example, depression hollows 14. The depression hollows 14 in this case essentially form a lowest point of the depressions in relation to the ridges 13, and the ridges 13 form a highest point, or a highest line. In proportion to the curves, or curvatures, the ridges 13 are however configured only narrowly.

The depth of the dome-shaped depressions may in this case lie between 10 µm and 0.1 µm, a depth of between 0.2 µm and 2 µm being preferred since the depth substantially determines the roughness of the recess wall 11, and in particular corresponds to a difference between a center of the depression hollow 14 and the ridge 13 enclosing the depression. This means that the depth of the depressions 12 substantially determines the mean roughness value (Ra) of the recess wall 11. Other factors, for example the grooves and/or intermediate regions 30, also make a contribution to the mean roughness value (Ra). In the best case, the mean roughness value (Ra) lies between 0.2 µm and 4.5 µm.

Furthermore, the depressions 12 have a cross section 15 which is preferably between 5 µm and 30 µm in size, in particular between 10 µm and 20 µm. The cross section 15, or the shape, of the depressions 12 may in this case be configured polygonally. The ridges 13 in this case form boundary lines between the depressions 12, it also being possible for the ridges 13 to also be angled by the polygonal shape of the depressions 12. Ideally, the depressions 12 are formed during the etching process in such a way that they form a space-saving cross section 15, for example having a number of vertices which is between 5 and 8, and preferably precisely 6, since this shape offers the mathematically smallest outline with at the same time the greatest spatial content, that is to say it most closely resembles a circular shape. In particular, a uniform and regular roughness may be adjusted in this way, and the glass element may therefore be adapted particularly accurately to the intended application.

FIG. 6 shows graphically depicted measurement values of the mean roughness value (Ra) on the recess wall 11 which were produced by the above-described combination of the introduction of damages 16 with a laser and the subsequent widening of the damages by etching to form channels 16. The mean roughness values (Ra) generated by the aforementioned process are represented in the graph as a function of various laser parameters. The mean roughness values (Ra) are plotted on the ordinate, the number of individual pulses of a burst, or pulse packet, lying on the abscissa. The size or diameter of the measurement points in this case represents the pitch or spacing of the pulses and channels. Furthermore, roughness measurement values of a roughness that was generated with a pulse duration of 1 ps are shown on the righthand side, and those which were generated with a pulse duration of 10 ps are shown on the lefthand side. The distribution of the mean roughness values (Ra) illustrates the dependency of the roughness on pulse duration, pulse number and the spacing of the pulses.

As the graph shows, lower mean roughness values (Ra), or a smoother surface of the recess wall 11, are generated with a short pulse duration of, for example, 1 ps than is the case for example with a longer pulse duration, for example 10 ps. In particular, the graph also shows that with a lower pulse duration, both the pitch and preferably also the burst or the individual pulse number have less influence than with a higher pulse duration. The measured mean roughness values (Ra) are therefore particularly high, for instance in the range of between 1 µm and 2 µm, with a higher pulse duration of about 10 ps, in particular with a high pitch and a high burst, while the mean roughness values (Ra) for a low pulse duration are less than 1 µm, independently of the pitch and burst. This means that a particularly low roughness of the recess wall 11 may be achieved with a low pulse duration.

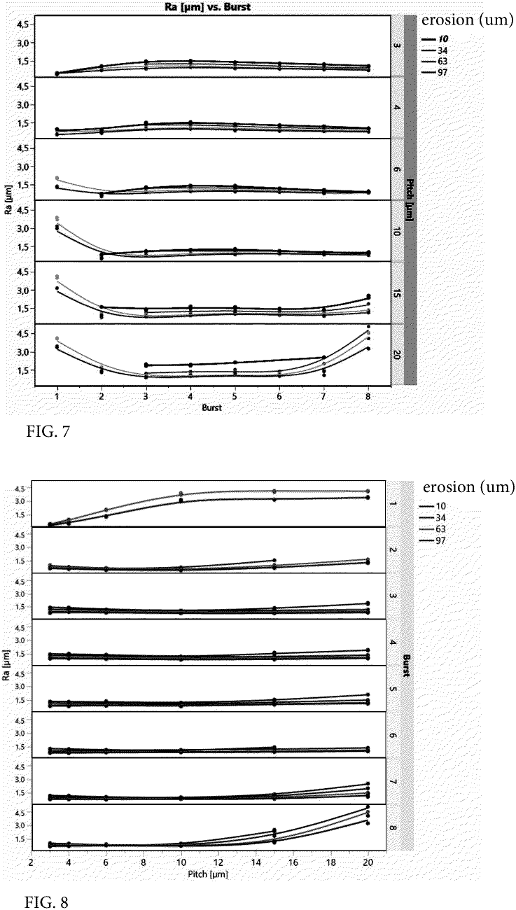

FIGS. 7 and 8 show graphically depicted measurement values of the mean roughness value (Ra) of the recess wall 11. However, the mean roughness values (Ra) are plotted as a function of the burst, that is to say the number of individual pulses (in FIG. 7 plotted on the abscissa; in FIG. 8 plotted on the ordinate) and the pitch, that is to say the spacing of the pulse packets (in FIG. 7 plotted on the ordinate; in FIG. 8 plotted on the abscissa). In both figures, measurement values of a roughness that was generated with a 10 ps pulse duration are represented. Lines connecting the measurement points in this case indicate the glass erosion which was eroded during the etching process. FIGS. 7 and 8 illustrate the dependency of the generatable roughness of the recess wall 11 and/or outer wall 11 on the pitch and burst. It is clear here that the roughness, or the measured mean roughness values (Ra), are particularly high, for example in the range of 3 µm or more, particularly with a high pitch beyond for example 12 µm and a high burst beyond for example 7. On the other hand, beyond a pitch above 6 µm the measured mean roughness values (Ra) are relatively high, for example more than 1.5 µm, even with a very low burst of between 1 and 2. Since the measurement value curves run substantially parallel and for the most part lie above one another, it may be deduced therefrom that the erosion has only a small influence on the generated roughness of the recess wall 11 and/or of the outer walls 4. Essentially, the roughness of the recess wall 11 and/or of the outer walls 4 may be adjusted by the selection of the laser parameters, in particular pulse duration, pitch and burst.

It is therefore apparent that particularly rough recess walls 11 and/or outer walls 4 may be generated with a parameter field that provides at least one of the following parameters, preferably a combination of the following parameters: long pulse durations, for example more than 1, preferably more than 3, preferably more than 5, a high number of individual pulses of a pulse packet (burst), for example 7 or more, a large pitch, for example 10 µm or more.

On the other hand, particularly smooth recess walls 11 and/or outer walls 4, in particular ones having a low roughness value, may be generated with a parameter field that provides at least one of the following parameters, preferably a combination of the following parameters:

short pulse durations, for example less than 5, preferably less than 3, preferably less than 1, a number of individual pulses of a pulse packet (burst) of between 2 and 7, a low pitch, for example less than 15 µm.

In a development of the method, however, it is provided that for the separation of one or more inner parts 20, at least a low pitch, that is to say spatial distance between two points of impact of the laser beam 100 on the glass element 1, or between at least two channels 16, is at most 6 µm, preferably at most 4.5 µm, and/or the erosion is more than 34 µm. In particular, a low pitch or a combination of high pitch and high erosion is advantageous in order to separate at least one inner part 20 so as to widen the channels during the etching process to such an extent that they join up. This may be carried out with a sufficiently high erosion.

FIGS. 6 to 8 thus illustrate that through the behavior of the glass material, or of the thermal expansion coefficient, the selected laser parameters have a crucial influence on the roughness of the recess wall 11. A glass that has a thermal expansion coefficient of less than 10×10⁻⁶ K⁻¹ is in this case purposely selected in order to be able to adjust the roughness in the best possible way. It may furthermore be advantageous for the thermal expansion coefficient to be more than 0.1×10⁻⁶ K⁻¹, preferably more than 1×10⁻⁶ K⁻¹, particularly preferably more than 2×10⁻⁶ K⁻¹, so that the glass has an expansion ability that is sufficient to induce a reaction to the energy of the laser. Without restriction to the proposed embodiments, glasses which have an SiO₂ fraction of between 30 wt% and 80 wt% and/or a TiO₂ fraction of at most 10 wt% in particular are suitable in respect of processability.

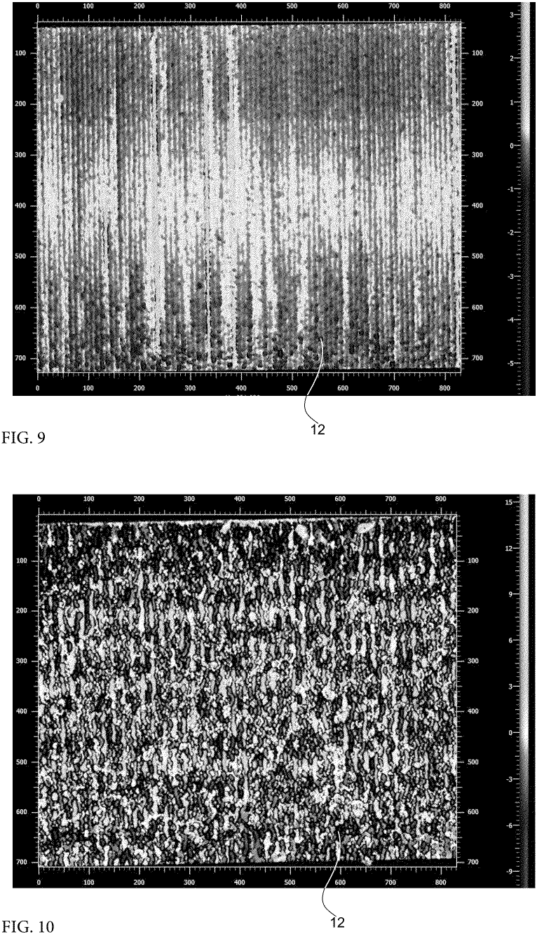

FIGS. 9 to 12 show surface measurements of the recess wall 11 having a direction-dependent roughness after erosion of 10 µm in the etching bath with a measurement region about 800 µm wide and about 750 µm high. In this case, the measurement region width runs parallel to the surface 2 of the glass element and the measurement height runs perpendicularly to the surface of the glass element 1, and in particular parallel to the laser beam 100. On the scale at the right edge of the image, the roughness or depth (in µm) of the depressions 12 relative to a central face of the recess wall 11 may be read.

FIGS. 9 and 10 depict recess walls 11 having a roughness that runs anisotropically, and particularly in the form of strips parallel to the laser beam, or perpendicularly/transversely to the surface 2 of the glass element 1. The factor A of the anisotropy is in this case preferably more than 1. This anisotropy is particularly pronounced with a short pulse duration of about 1 ps, a low burst of 2 and a pitch of 10 µm, as represented in FIG. 9. The dome-shaped depressions 12 can be seen only with difficulty, but are evidently pronounced in the manner of a grid, or arranged with respect to one another in a similar way to a grid, in particular arranged above one another in the direction of the laser beam, in such a way that an arrangement of the depressions 12 form strips that run perpendicularly/transversely to the surface 2 of the glass element. The depressions 12 in this case show a round, sometimes circular cross section.

The situation is different with a recess wall 11 that was produced with 10 ps, a burst of 1 and a pitch of 10 µm, as depicted in FIG. 10. As in FIG. 9, the roughness is configured anisotropically and runs in particular parallel to the laser beam, or perpendicularly/transversely to the surface 2 of the glass element 1. The individual depressions 12, however, are in this case configured rather vermiformly, they the vermiform shape preferably extending along a direction which runs parallel to the laser beam 100 and/or perpendicularly/transversely to the surface 2 of the glass element 1. In the context of the invention, vermiform is intended to mean that the ridges 13 form a nonuniform height around a depression 12 and regionally have a height which may correspond to the depth of the depression, or at least is much less than the height of a majority of the ridge 13 enclosing the depression. When there are two or more mutually adjacent depressions having such small heights of at least one region of the ridge 13, the depressions 12 appear with an approximately uniform depth in the measurement image, so that the vermiform shape consisting of a concatenation of individual depressions 12 results. It is evident overall that when using a pulse duration of 10 ps (FIG. 10; mean roughness value of 0.50 µm), the recess wall 11 is configured much more coarsely, and therefore in a more matt fashion, or more roughly, than when using a pulse duration of 1 ps (FIG. 9; mean roughness value of 0.38 µm). The mean roughness value (Ra) may therefore be adjusted particularly accurately by varying the pulse duration.

FIG. 11 depicts a recess wall 11 having a roughness which is configured anisotropically, preferably in the form of strips that run transversely to the laser beam 100 and/or parallel to the surface 2 of the glass element 1. The factor A of the anisotropy is in this case preferably less than 1. The recess wall 11 in this case shows essentially two regions which run in the form of strips, the depressions 12 of each region preferably having a uniform depth so that the regions essentially differ by the depth of the depressions. This leads to relatively uniform gray values of the measurement results or mean roughness values (Ra) of each region.

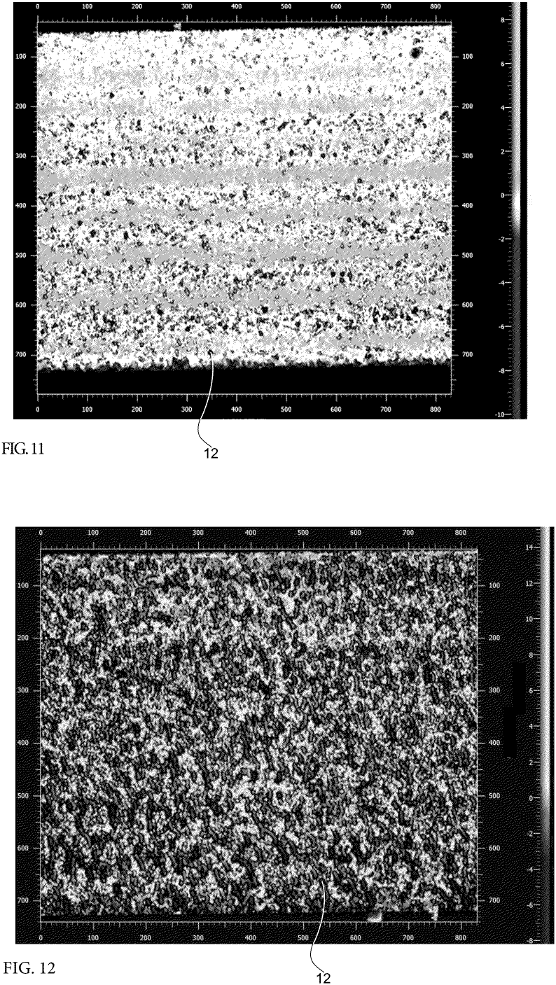

FIG. 12 shows a recess wall 11 having a mean roughness value of 1.05 µm, which was generated with a pulse duration of 10 ps, a burst of 2 and a pitch of 3 µm. In this example, the dome-shaped depressions 12 are distributed substantially homogeneously over the recess wall 11 so that only a very low anisotropy, or even no anisotropy, is formed. The cross section of the depressions 12, which are preferably configured roundly to ovally, is also relatively similarly pronounced, so that a uniform structure is formed on the recess wall 11.

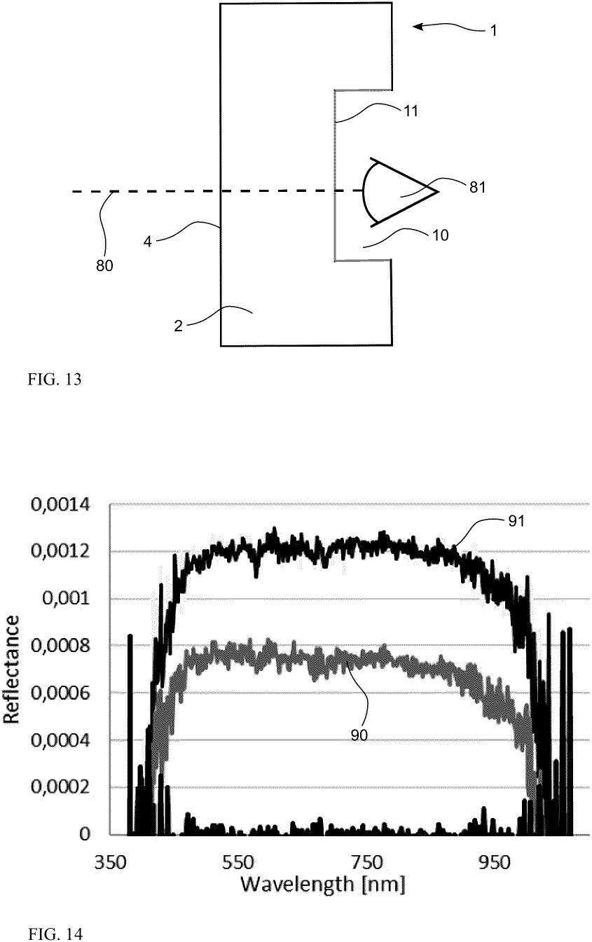

FIGS. 13 and 14 schematically show a layout of transmission measurements and measurement results of reflection measurements. The glass element may advantageously be configured transparently, in particular allowing transmission of visible light, or in general light which lies in the wavelength range of between 300 nm and 1000 nm. The structuring, generated by the method presented above, of the recess wall 11 and/or outer wall 4 have advantageous light-shaping properties in order to suppress, for example, speckle effects in the case of laser diodes or other interference effects. For this purpose, the depressions 12, or the structure of the wall, may for example be configured homogeneously or anisotropically, in particular according to the forms represented in FIGS. 9-12, in order to influence the light passing through. Preferably, the glass element 1 is capable of letting light pass through both the recess wall 11 and/or outer wall 4 and through the surfaces 2 of the glass element, so that electromagnetic waves can be emitted or received through the glass element 1.

Particularly advantageously, the wall 11, 4, especially in the case of a roughness adjusted by the aforementioned method of 0.5 µm (Ra), and the volume of the glass element 1 are capable of transmitting more than 90% of the light in the wavelength range between 300 nm and 1000 nm. If the wall 11, 4 is intended to have a lower transmission, however, the mean roughness value (Ra) may for example be adjusted to a value of 1.4 µm, so that for example only just over 86% of the light is transmitted and more light in the wavelength range of between 300 nm and 1000 nm is reflected.

It was possible to demonstrate this inter alia by the measurement layout schematically shown in FIG. 13. It was possible to measure the transmission by means of an Ulbricht sphere 81, or an integrating sphere 81, and a light beam 80, for example a light beam 80 having a wavelength of 690 nm. In this case, the light beam 80 traveled through approximately a 10 mm volume of the glass element 1, an outer wall 4, which may be specially polished, and passed or was guided through the recess wall 11. The recess wall 11 is in this case arranged in such a way that it is arranged at or directly before the entry position of the Ulbricht sphere 81. In this way, the light beam can be scattered on the wall 11, 4 and all angles can be recorded by means of the Ulbricht sphere 81. In order to be able to determine the transmission of the wall 11, 4 independently of the volume of the glass element 1, and/or of another wall, it is also conceivable to subtract a transmission fraction of the volume of the glass element 1 and/or of a polished wall from the measurement result of the transmission. In order to be able to determine the transmission fraction of the volume of the glass element 1 and/or of the further wall, the transmission of the glass element may for example be measured in such a way that the light is guided through the surface 2 of the glass element 1, or by means of reflection measurements the degree of light reflection of a wall is determined, and this may subsequently be subtracted from the overall measurement result of the transmission measurements.

FIG. 14 shows the results of a reflection measurement. By means of a light waveguide, or a fiber sampler, light was directed onto the wall 11, 4 and the light reflected by the wall 11, 4 in the wavelength range of between 300 nm and 1000 nm was recorded. Advantageously, the recorded measurement results make it clear that the degree of reflection can be adjusted by the roughness of the wall 11, 4, or a desired reflectance may be adjusted with the aid of the roughness. It is found that, for example, the reflection of the light in the case of a rough wall 11, for example with a mean roughness value of 1.4 µm, is much less than with a less rough or even smooth wall 11, 4, for example having a mean roughness value of 0.5 µm.

LIST OF REFERENCES

| | |
|---|---|
| 1 | panel-shaped glass element |
| 2 | surfaces |
| 4 | outer wall |
| 10 | recess |
| 11 | recess wall |
| 12 | dome-shaped depressions |
| 13 | ridges |
| 14 | depression hollow |
| 15 | cross section |
| 16 | channel/damages |
| 17 | structure |
| 18 | vertices |
| 20 | inner part |
| 30 | intermediate regions |
| 31 | channel regions |
| 50 | holders |
| 70 | erosion |
| 80 | light beam |
| 81 | Ulbricht sphere/integrating sphere |
| 90 | rough wall |
| 91 | smooth wall |
| 100 | laser beam |
| 101 | laser/ultrashort-pulse laser |
| 102 | focusing optics |
| 200 | etchant |
| 202 | container |
| L | longitudinal direction |
| Q | transverse direction |
| D | thickness of the glass element |

What is claimed is:

1. A panel-shaped glass element, comprising:
a vitreous material having a thickness defined between two opposing surfaces, the vitreous material having a thermal expansion coefficient of less than 10×10⁻⁶ K⁻¹;
a recess defined through the thickness of vitreous material so that the recess has a recess wall that adjoins the two opposing surfaces; and
a plurality of depressions defined in the recess wall such that the recess wall has a mean roughness value that is at least 50 nm and less than 5 µm, wherein each of the plurality of depressions have a rounded dome-shape hollow and a ridge enclosing the rounded dome-shape hollow.

2. The panel-shaped glass element of claim 1, wherein the recess has a recess depth that is transverse to at least one of the two opposing surfaces.

3. The panel-shaped glass element of claim 1, wherein the recess has a recess depth that is perpendicular to at least one of the two opposing surfaces.

4. The panel-shaped glass element of claim 1, wherein the mean roughness value is less than 1 µm.

5. The panel-shaped glass element of claim 1, wherein the plurality of depressions have a depth that is less than 10 µm, the depth being defined by a difference between a center of the rounded dome-shape hollow and an average peak of the ridge.

6. The panel-shaped glass element of claim 1, wherein the rounded dome-shape hollow has a diameter that is less than 20 µm.

7. The panel-shaped glass element of claim 1, further comprising an outer wall that runs around the thickness of the vitreous material and connects the two opposing surfaces to one another, the outer wall having a plurality of second depressions, wherein each of the plurality of second depressions have a second rounded dome-shape hollow and a second ridge enclosing the second rounded dome-shape hollow.

8. The panel-shaped glass element of claim 7, wherein the outer wall has a second mean roughness value that is more than 0.2 µm.

9. The panel-shaped glass element of claim 7, further comprising a transmission of visible light in a wavelength range of between 300 nm and 1000 nm that is more than 80% for light having a direction oriented parallel to at least one of the two opposing surfaces.

10. The panel-shaped glass element of claim 9, wherein the transmission is more than 90%.

11. The panel-shaped glass element of claim 7, wherein the mean roughness value is configured anisotropically and the anisotropy is expressed as a parameter A, with A being a square of a quotient, the quotient being formed from an average value of the mean roughness value of three 30 µm wide measurement bands oriented parallel to the outer wall and the average value of the mean roughness values of three 30 µm wide measurement bands which are oriented perpendicularly to the outer wall, the anisotropy being less than 1.

12. The panel-shaped glass element of claim 7, wherein the mean roughness value is configured anisotropically and the anisotropy is expressed as a parameter A, with A being a square of a quotient, the quotient being formed from an average value of the mean roughness value of three 30 µm wide measurement bands oriented parallel to the outer wall and the average value of the mean roughness values of three 30 µm wide measurement bands which are oriented perpendicularly to the outer wall, the anisotropy more than 1.

13. The panel-shaped glass element of claim 7, wherein the recess wall and/or the outer wall has a roughness that is direction-dependent either transverse to the thickness or parallel to the thickness.

14. The panel-shaped glass element of claim 1, wherein the vitreous material comprises glass having a constituent selected from a group consisting of: an SiO₂ fraction of at least 30 wt%, an SiO₂ fraction of at least 50 wt%, an SiO₂ fraction of at least 80 wt%, and a TiO₂ fraction of at most 10 wt%.

15. The panel-shaped glass element of claim 1, wherein the panel-shaped glass element os configured for a field of use selected from a group consisting of: camera imaging, 3D camera imaging, pressure sensing, packaging of electro-optical components, biotechnology, diagnosis, and medical technology.

16. A method for producing a panel-shaped glass element, comprising:
providing a vitreous material having a thickness defined between two opposing surfaces, the vitreous material having a thermal expansion coefficient of less than 10×10⁻⁶ K⁻¹;
directing a laser beam of an ultrashort-pulse laser onto one of the two opposing surfaces through focusing optics in order to form an elongate focus in the vitreous material until a plurality of filamentary channels are generated in the thickness by incident energy of the laser beam, the plurality of filamentary channels having a depth that runs transverse to the thickness and being arranged at a distance from one another;
exposing the vitreous material to an etchant that erodes the vitreous material to widen the plurality of filamentary to define a recess through the thickness of vitreous material with a recess wall adjoining the two opposing surfaces and with a plurality of depressions in the recess wall, wherein each of the plurality of depressions have a rounded dome-shape hollow and a ridge enclosing the rounded dome-shape hollow; and
adjusting parameters of the laser beam so that the recess wall has a mean roughness value that is at least 50 nm and less than 5 µm.

17. The method of claim 16, wherein the distance between the plurality of filamentary channels is more than 1 µm and less than 20 µm.

18. The method of claim 16, wherein the distance between the plurality of filamentary channels is more than 3 µm and less than 10 µm.

19. The method of claim 16, further comprising controlling the laser beam to provide a laser pulse that is divided into a multiplicity of individual pulses with a multiplicity of more than 1 and less than 10.

20. The method of claim 16, further comprising controlling the laser beam to provide a pulse duration that is less than 15 ps.
